(19) United States
(12) Patent Application Publication
(10) Pub. No.: US 2026/0125121 A1
(43) Pub. Date: May 7, 2026

(54) TRACK SYSTEM AND VEHICLE HAVING SAME

(71) Applicant: SOUCY INTERNATIONAL INC., Drummondville (CA)

(72) Inventors: Charles ST-ARNAUD, Trois-Rivieres (CA); Gabriel LANDRY, Saint-Mathieu (CA)

(21) Appl. No.: 19/377,199

(22) Filed: Nov. 3, 2025

Related U.S. Application Data
(60) Provisional application No. 63/716,332, filed on Nov. 5, 2024.
(60) Provisional application No. 63/771,776, filed on Mar. 14, 2025.

(51) Int. Cl. B62D 55/084; B62D 55/065

(52) U.S. Cl. CPC B62D 55/084; B62D 55/065

(57) ABSTRACT

An angular limiting system for a track system that is configured to be drivingly connected to an axle of a vehicle, and that is configured to be pivotally connected to the axle about an axis, includes an axle member and a frame member. The axle member is configured to be connected to the axle of a vehicle. The frame member is configured to be connected to a frame of the track system, and is configured to cooperate with the axle member for limiting movement of the track system in response to an angle between part of the track system and the axle about the axis reaching a predetermined angular limit.

### CROSS-REFERENCE TO RELATED APPLICATIONS

The present application claims priority to U.S. Provisional Patent Application No. 63/716,332, filed Nov. 5, 2024 entitled “Track System and Vehicle Having Track System”, and U.S. Provisional Patent Application No. 63/771,776, filed Mar. 14, 2025 entitled “Track System and Vehicle Having Track System”, which are incorporated by reference herein in their entirety.

### TECHNICAL FIELD

The present technology relates to track systems, vehicles having track systems, systems for limiting angular range of motion, vehicle having systems for limiting angular range of motion, and axles for vehicles having track systems.

### BACKGROUND

Certain vehicles, such as, for example, vehicles used in agriculture (e.g., harvesters, combines, tractors, etc.), in construction, in forestry, in mining and in powersports, are used on ground surfaces that are soft, slippery and/or uneven (e.g., soil, mud, sand, ice, snow, etc.). In some instances, such vehicles may be equipped with implements used to perform agricultural work (e.g., seeding, spraying, harvesting, etc.) or to perform other works (e.g. plow, trailer, etc.).

Conventionally, such vehicles have a chassis and ground engaging assemblies each comprising a wheel mounted with a tire to operate the vehicle along the ground surface. Under certain conditions, such assemblies may have poor traction and stability on some kinds of ground surfaces. Additionally, the tires may compact or damage the ground surface due to a load sustained by the tires being concentrated over a limited ground engaging contact patch area. As an example, when the vehicle is an agricultural vehicle, the tires may compact the soil in such a way as to undesirably inhibit the growth of crops. Furthermore, stability issues due to poor floatation over a ground surface that is uneven or yielding under such pressure may damage the vehicle (e.g., a spray boom extremity colliding with the ground surface or a plow extremity colliding with the ground) or reduce the quality of the work being performed (e.g., uneven spraying of pesticides or uneven scrapping of ground surface). Such stability issues can be similarly problematic for other types of vehicles as well.

In order to reduce the aforementioned drawbacks, it was deemed desirable to increase stability and traction by distributing the weight of the vehicle across a larger ground engaging contact area on the ground surface, and track systems were developed to be used as ground engaging assemblies in place of at least some of the wheels and tires on the vehicles.

Replacing the wheels and tires by a track system, however, does present inherent inconveniences due the needed management of interferences between the newly installed track system and the chassis of the vehicle. Since the track systems are mobile around an axle of the vehicle, their longitudinal displacement must be limited and known track systems are usually equipped with limiting devices. Such limiting devices are even more important for steered vehicles because the interferences can even be greater. Known limiting devices typically comprise stoppers that keep the track system in its intended orientation when an angle between the track system and a horizontal plane, for instance, reaches a predetermined value. However, a worst case has to be taken into account when choosing said predetermined value of the angle, which drastically reduces the performance of the track system to conform to the ground surface it rolls on and therefore reduces mobility of the vehicle in its main use.

Another problem arises when a stopper abuts against the chassis, since a high momentum is applied to the steering knuckle of the vehicle and can provoke the breaking of the steering knuckle.

Therefore, there is a desire to improve on known solutions for ameliorating performance of track systems.

### SUMMARY

In one broad aspect of the present technology, there is provided a track system for a vehicle. The track system comprises a frame, a plurality of wheel assemblies rotationally connected to the frame and an endless track surrounding the frame and the plurality of wheel assemblies. The plurality of wheel assemblies comprises a drive wheel assembly drivingly engaged with the endless track. The drive wheel assembly is drivingly engageable with an axle of the vehicle.

In some embodiments of the present technology, the vehicle may comprise an articulation assembly configured to pivotably connect the frame of the track system to the axle of the vehicle and/or to another component of the vehicle. The articulation assembly may be configured to pivotably connect the frame to the axle so as to allow pivoting movement of the frame relative to the axle about at least one of (i) a roll axis, (ii) a pitch axis, and (iii) a yaw axis of the track system. In some embodiments, the vehicle may comprise a steering knuckle configured to allow pivoting of the frame relative to the axle about a steering axis of the vehicle and/or a yaw axis of the track system. In some embodiments, the drive wheel assembly is drivingly connected to the axle and may allow pivoting of the frame relative to the axle about a pitch axis of the track system.

It should be noted that pivoting of the track system relative to the axle may aid during operation of the vehicle, such as when steering (pivoting about a yaw axis), climbing a hill (pivoting about a pitch axis), and/or performing tight turns (pivoting about a roll axis), for example. Developers have realized that although a pivoting motion of the track system relative to the axle may be beneficial, one or more components of the track system and/or the vehicle may be damaged in at least some scenarios due to the pivoting motion. In some scenarios, the track system may come into contact with the vehicle body if the pivot motion is not limited to a certain predetermined range that takes into account the surroundings of the pivoting track system. In other scenarios, stress may be applied on one or more components of the steering knuckle of the vehicle and/or the articulation assembly of the vehicle if the pivot motion is not limited.

This may particularly be the case in composite motion, i.e. when a pivot motion of the track system relative to the axle about more than one axis occurs such as, for example, when the track system is simultaneously steered and tilted. Composite motion is typically more severe in terms of risks of contact between the track system and the vehicle than single pivot motion. For this reason, conventional track systems are typically configured for conservatively limiting the range of motion of the track system relative to the vehicle in accordance with the worst-case scenario. Doing so may be beneficial for reducing risks of contact between the track system and the vehicle for a given worst-case motion, but may be detrimental for the overall performance of the track system and/or vehicle by applying such conservative limit to any other given motions.

In one broad aspect of the present technology, there is provided an angular limiting system for a track system. The angular limiting system is configured to limit the pivoting motion between the frame of the track system and the axle of the vehicle. The angular system is configured to transfer loads from the frame to the axle when the frame reaches a threshold angle, and which would otherwise be applied onto the steering knuckle of the vehicle and/or the articulation assembly of the vehicle.

In addition, broadly, the angular limiting system is configured to provide an optimized range of motion for any single pivot motion and/or composite motion, so that the performance of the track system—intimately related to pivotal motion thereof relative to the vehicle, is maximized. In some embodiments, the angular limiting system is configured to optimize a composite motion including steering and pivoting of the track system relative to the vehicle about a steering axis and at least one of a pitch axis and a roll axis.

The angular limiting system comprises an axle member arranged to be fixed to the axle and a frame member arranged to be fixed to the frame. In some embodiments, the axle member is selectively connectable to the axle. In other embodiments, the axle member is integral with the axle. In some embodiments, the frame member is selectively connectable to the frame. In other embodiments, the frame member is integral with the frame. It is contemplated that the angular limiting system may be provided separately from a vehicle and/or a track system and can be installed on the vehicle and/or the track system, without departing from the scope of the present technology.

The frame member is configured to cooperate with the axle member to prevent movement of the track system when an angle, between the track system and the axle about an axis, reaches a limiting angular value. In some embodiments, the axis is a pitch axis and the angle is a pitch angle of the track system. In other embodiments, the axis is a roll axis and the angle is a roll angle of the track system. In further embodiments, the axis is a yaw axis and the angle is a yaw angle of the track system. In other embodiments, the axis is a composite axis including at least one of the pitch axis, roll axis and yaw axis and the angle is a composite angle.

The relative position and/or orientation between the axle member and the frame member may depend on inter alia a geometry of a given track system and a geometry of a given vehicle. For example, the axle member on an axle of the given vehicle and the frame member on a frame of the given track system may be disposed and/or oriented relative to one another such that when the angle between the axle of the specific vehicle and the frame of the specific track system reaches the limiting angular value, the frame member abuts against the axle member and prevents further pivoting. In some embodiments, it can be said that the limiting angular value is a predetermined limiting angular value.

Each of the axle member and the frame member has at least one engaging/contact surface. In some embodiments, the at least one engaging surface may be at least one flat engaging surface. In other embodiments, the at least one engaging surface may have a non-flat topology. For example, a topology of the at least one engaging surface may exhibit valleys and hills. In some embodiments, the at least one engaging surface may define a first curved path in a first direction of travel along the at least one engaging surface and a second curved path in a second direction of travel along the at least one engaging surface, and where the first curved path is different from a second curved path.

According to one aspect of the present technology, there is provided an angular limiting system. The angular limiting system is for an axle and track system assembly for a vehicle, the track system being rotatable around an axis, called pitch axis, the angular limiting system comprising a first plate, called bottom plate, arranged to be fixed to said axle, the track system comprising an extension configured to cooperate with the bottom plate to stop the track system when a pitch angle reaches a predetermined maximal value, called limiting angle.

In some embodiments, the angular limiting system further includes another plate, called top plate, the top plate and bottom plate being configured to be located on both sides of the axle, the top and bottom plates being fastened one to another.

In some embodiments, the extension includes at least one plate forming a non-zero angle with a ground level of the track system, said at least one plate being arranged to be in contact with the bottom plate when the limiting angle is reached.

In some embodiments, the non-zero angle is an acute angle.

In some embodiments, the non-zero angle is comprised between 5° and 45°.

In some embodiments, the extension comprises a first plate and a second plate, in line with each other.

In some embodiments, the extension comprises at least one path with a typology arranged to maximize the angular limiting angle depending on values of a steering angle.

According to another aspect of the present technology, there is provided an axle and track system assembly for a vehicle, including at least one angular limiting system according to the above aspect or according to the above aspect and one or more of the above embodiments.

In some embodiments, the axle and track system assembly, further include a device for engaging the track system relative to the axle, having an element engaged to a pivot of the track system and a bracket coupled to both the element engaged to the pivot and a steering knuckle of the axle.

In some embodiments, the axle and track system assembly further includes another plate, called top plate, the top plate and bottom plate being located on both sides of the axle, the top and bottom plates being fastened one to another with the axle.

According to another aspect of the present technology, there is provided a track system for a vehicle, which includes an extension configured to cooperate with a bottom plate of an angular limiting system according to the above aspect to stop the track system when the pitch angle reaches a predetermined maximal value, called limiting angle.

In some embodiments, the extension comprises at least one plate forming a non-zero angle with a ground level of the track system, said at least one plate being arranged to be in contact with the bottom plate when the limiting angle is reached.

In some embodiments, the non-zero angle is an acute angle.

In some embodiments, the non-zero angle is comprised between 5° and 45°.

In some embodiments, the extension comprises a first plate and a second plate, in line with each other.

In some embodiments, the extension comprises at least one path with a typology arranged to maximize the angular limiting angle depending on values of a steering angle.

According to an other aspect of the present technology, there is provided an axle for the axle and track system assembly according to one of the above aspects having ribs protruding to a main body of the axle, two ribs being spaced to receive a fastening element to fix the top plate and the bottom plate to the axle.

According to another aspect of the present technology, there is provided an angular limiting system for a track system configured to be drivingly connected to an axle of a vehicle, and to be pivotally connected to the axle about an axis, the angular limiting system including: an axle member configured to be connected to the axle of a vehicle; and a frame member configured to be connected to a frame of the track system, and configured to cooperate with the axle member for limiting movement of the track system in response to an angle between part of the track system and the axle about the axis reaching a predetermined angular limit.

In some embodiments, the axis is a pitch axis and the angle is a pitch angle of the track system; the axis is a roll axis and the angle is a roll angle of the track system; or the axis is a yaw axis and the angle is a yaw angle of the track system.

In some embodiments, the angular limiting system further includes a plate configured to connect to the axle; the frame member includes an extension including an external surface; and the plate and the external surface are positioned to be in contact for limiting relative movement about the axis.

In some embodiments, the axis is a first axis; the angle is a first angle; the predetermined angular limit is a first predetermined angular limit; and the track system is further configured to pivot relative to the axle about a second axis, and the frame member is configured to cooperate with the axle member for limiting movement of the track system in response to a second angle between part of the track system and the axle about the second axis reaching a second predetermined angular limit.

In some embodiments, the first axis is one of: a pitch axis, and the first angle is a pitch angle of the track system; a roll axis, and the first angle is a roll angle of the track system; or a yaw axis, and the first angle is a yaw angle of the track system, the second axis is an other one of: the pitch axis, and the second angle is a pitch angle of the track system; the roll axis, and the second angle is a roll angle of the track system; or the yaw axis, and the second angle is a yaw angle of the track system.

In some embodiments, the angular limiting system further includes a plate configured to be connected to the axle; the frame member includes an extension including an external surface; and the plate and the external surface are positioned to be in contact so as to limit relative movement about the first axis and the second axis.

In some embodiments, the extension includes at least two races forming cam surfaces configured to engage the plate.

In some embodiments, the plate is configured to slide on the at least two races.

In some embodiments, the races are shaped to provide a composite range of motion of about 80 degrees about the first axis and the second axis.

In some embodiments, the races are shaped to allow a composite range of motion of about 60 degrees about the first axis and the second axis.

In some embodiments, the races are shaped to allow a composite range of motion of about 5 degrees about the first axis and the second axis.

In some embodiments, the axle member is configured to be selectively connected to the axle; or the axle member is configured to be integral with the axle.

In some embodiments, the frame member is configured to be selectively connected to the frame; or the frame member is configured to be integral with the frame.

In some embodiments, the frame member has a frame plate defining an angle with a horizontal plane.

In some embodiments, the angle is between about 5° and about 45°.

In some embodiments, the frame member is a first frame member; and the angular limiting system further includes a second frame member configured to be connected to the frame, and configured to cooperate with the axle member for limiting movement in response to an angle between part of the track system and the axle about the axis reaching a second limiting angular value.

In some embodiments, the frame member includes at least one surface with a typology arranged such that: with a yaw angle of the track system being a first yaw angular value, the limiting angular value is a first limiting angular value; with the yaw angle of the track system being a second yaw angular value, the limiting angular value is a second limiting angular value; and the first limiting angular value is different from the second limiting angular value.

In some embodiments, the frame member has stoppers.

According to another aspect of the present technology, there is provided a track system including a frame configured to connect to an axle of a vehicle, the frame being pivotable relative to the frame about an axis; a plurality of wheel assemblies rotationally connected to the frame, the plurality of wheel assemblies including a drive wheel assembly configured to be drivingly connected to the axle of the vehicle; an endless track surrounding the plurality of wheel assemblies and drivingly engaged with the drive wheel assembly; and the angular limiting system according to the above aspect or according to the above aspect and one or more of the above embodiments.

According to another aspect of the present technology, there is provided a vehicle including: a frame; a motor supported by the frame; an axle supported by the frame and operatively connected to the motor; a track system drivingly and pivotably connected to the axle; and the angular limiting system according to the above aspect or according to the above aspect and one or more of the above embodiments.

Developers of the present technology have realized that providing at least one engaging surface with a non-flat topology may allow the angular limiting system to define a first limiting angular value when a yaw angle of the track system is a first yaw angular value, and a second (different) limiting angular value when the yaw angle of the track system is a second yaw angular value. It should be noted that depending on the yaw angle, different paths of the at least one engaging surface may be used to cooperate with the opposite engaging surface. As a result, different limiting angular values may be defined for different steering angles of the vehicle.

The use of “including”, “comprising”, or “having”, “containing”, “involving” and variations thereof herein, is meant to encompass the items listed thereafter as well as, optionally, additional items.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns.

It must be noted that, as used in this specification, the singular form “a”, “an” and “the” include plural referents unless the context clearly dictates otherwise.

As used herein, the term “about” in the context of a given value or range refers to a value or range that is within 20%, preferably within 10%, and more preferably within 5% of the given value or range.

As used herein, the term “and/or” is to be taken as specific disclosure of each of the two specified features or components with or without the other. For example, “A and/or B” is to be taken as specific disclosure of each of (i) A, (ii) B and (iii) A and B, just as if each is set out individually herein.

For purposes of the present application, terms related to spatial orientation when referring to a track system and components in relation to the track system, such as “vertical”, “horizontal”, “forwardly”, “rearwardly”, “left”, “right”, “above” and “below”, are as they would be understood by a driver of a vehicle to which the track system is connected sitting thereon in an upright driving position, with the vehicle steered straight-ahead and being at rest on flat, level ground. It is understood that the same applies for driver-free or autonomous vehicles.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a schematic left side view of a vehicle having track systems according to embodiments of the present technology;

FIG. 2 is a perspective schematic view of an axle-track system assembly according to an embodiment of the present technology;

FIG. 3 is another perspective schematic view of the axle-track system assembly of FIG. 2;

FIG. 4 is a perspective schematic view of details of the axle-track system assembly of FIG. 2;

FIG. 5 is another perspective schematic view of details of the axle-track system assembly of FIG. 2;

FIG. 6 is a top plan view of a bottom plate of the axle-track system assembly of FIG. 2.

FIG. 7 is a perspective schematic view of the axle-track system assembly of FIG. 2 with the track system being steered at a maximal steering angle;

FIG. 8 is a perspective schematic view of an axle-track system assembly according to another embodiment of the present technology;

FIG. 9 is a perspective schematic view of details of the axle-track system assembly of FIG. 8;

FIG. 10 is a bottom view of a bottom plate of the axle-track system assembly of FIG. 8;

FIG. 11 is a schematic left side view of a vehicle having track systems with the axle-track system assembly of FIG. 8, with the front track systems being oriented straight and disposed on a level surface;

FIG. 12 is a side view of part of the axle-track system assembly of the front left track system of the vehicle of FIG. 11;

FIG. 13 is a front view of the part of the axle-track system assembly of FIG. 12;

FIG. 14 is a schematic left side view of the vehicle of FIG. 11 with the front track systems being steered left and being pivoted about a pitch axis;

FIG. 15 is a perspective front view of the part of the axle-track system assembly of the front left track system of FIG. 14;

FIG. 16 is another perspective front view of the part of the axle-track system assembly of FIG. 15;

FIG. 17 is another perspective rear view of the part of the axle-track system assembly of FIG. 15;

FIG. 18 is yet another perspective view of the part of the axle-track system assembly of FIG. 15;

FIG. 19 is a top plan view of part of the axle-track system of FIG. 15;

FIG. 20 is a schematic left side view of the vehicle of FIG. 11 with the front track systems being steered to the right at a maximum angle and being pivoted about a pitch angle to a maximum pitch angle;

FIG. 21 is a perspective view of part of the axle-track system assembly of the front left track system of the vehicle of FIG. 20;

FIG. 22 is another perspective view of the part of the axle-track system assembly of FIG. 21;

FIG. 23 is another perspective view of the part of the axle-track system assembly of FIG. 21; and

FIG. 24 is a top plan view of the axle-track system of FIG. 21.

### DETAILED DESCRIPTION

### Introduction

It is to be expressly understood that the various embodiments of the angular limiting system are merely embodiments of the present technology. Thus, the description thereof that follows is intended to be only a description of illustrative examples of the present technology. This description is not intended to define the scope or set forth the bounds of the present technology. In some cases, what are believed to be helpful examples of modifications or alternatives to apparatus may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e., where no examples of modifications have been set forth), it should not be interpreted that no modifications are possible and/or that what is described is the sole manner of implementing or embodying that element of the present technology. As a person skilled in the art would understand, this is likely not the case. In addition, it is to be understood that the apparatus may provide in certain aspects a simple embodiment of the present technology, and that where such is the case it has been presented in this manner as an aid to understanding. As persons skilled in the art would understand, various embodiments of the present technology may be of a greater complexity than what is described herein.

In the following description, the same numerical references refer to similar elements.

A coordinate axis (X, Y, Z) is drawn on the figures to help the understanding of the present patent application. The X-axis corresponds to a roll direction, the Y-axis corresponds to a pitch direction and the Z-axis corresponds to a yaw direction.

### Vehicle

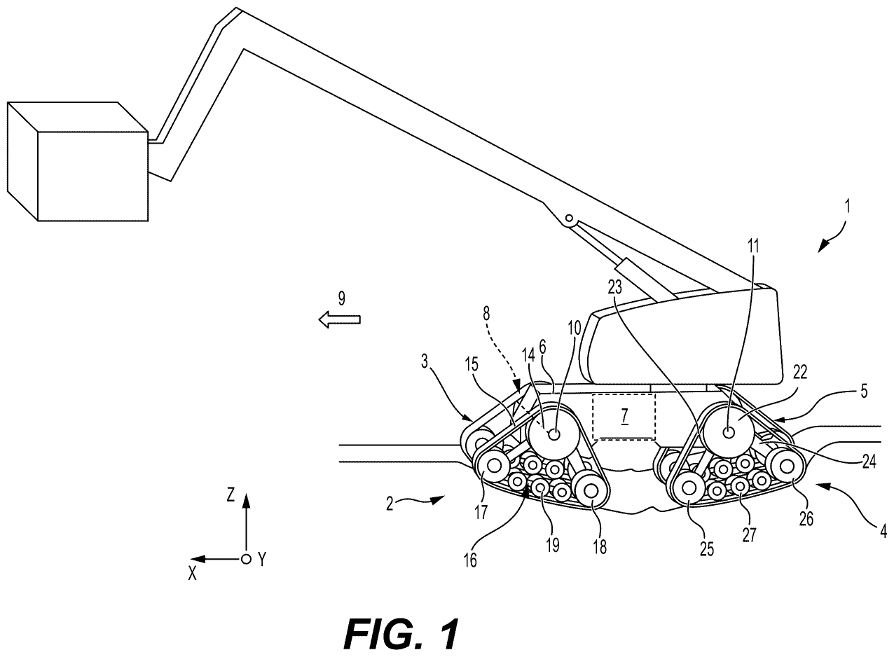

With reference to FIG. 1, there is depicted a vehicle 1 that is equipped with track systems according to embodiments of the present technology. The forward direction of the vehicle 1 is indicated by arrow 9.

In this embodiment, the vehicle 1 is a construction vehicle 1. The present technology is not limited to this kind of vehicle. For example, the present technology could be used with other types of vehicles having track systems, such as off-road (powersports or not) vehicles, all-terrain vehicles, side-by-side vehicles, agricultural vehicles, industrial vehicles, military vehicles or exploratory vehicles.

The vehicle 1 has four track systems 2, 3, 4, 5. The track systems 2, 3 are front track systems, and the track systems 4, 5 are rear track systems. In some embodiments, the vehicle 1 could have more or less than four track systems.

As can be seen from FIG. 1, the vehicle 1 includes a frame 6. The vehicle 1 also includes a powertrain 7 (schematically shown), a steering system 8 (also schematically shown), and a suspension system (not shown). In some instances, the frame 6 may have a cabin disposed thereon.

The powertrain 7, which is supported by the frame 6, is configured to generate and transmit power to at least one of the track systems 2, 3, 4, 5 via driving axles, thereby driving the vehicle 1. In some embodiments, the powertrain 7 could include an electric motor or an internal combustion engine. Particularly, the front track systems 2, 3 are operatively connected to a front axle 10 and, the rear track systems 4, 5 are operatively connected to a rear axle 11. It is contemplated that in some embodiments, the powertrain 7 could be configured to drive the front and the rear axles 10, 11, only the front axle 10 or only the rear axle 11 (i.e., in some embodiments, the front axle and/or rear axle could be a driving axle).

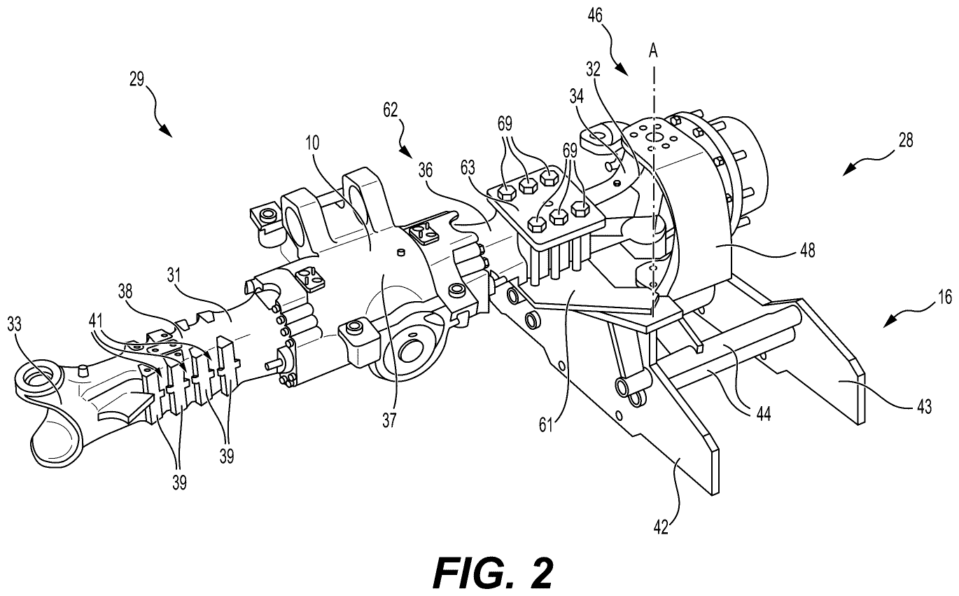

The steering system 8 enables the vehicle 1 to be steered. To this end, the steering system 8 includes a steering wheel or a handlebar that is operable by an operator to direct the vehicle 1 along a desired course. The steering system 8 is configured so that in response to the operator handling the steering wheel or handlebar, the front track systems 2, 3 and/or rear track systems 4, 5 change their orientation relative to the frame 6, thereby causing the vehicle 1 to turn in a desired direction. Thus, the steering system 8 includes one or more steering knuckles (see steering knuckle 34 in FIG. 2, for example) operatively connecting a frame of a given track system to a respective axle of the vehicle 1.

### Front Track System

Still referring to FIG. 1, the track system 2 is a front left track system 2 and the track system 3 is a front right track system 3. The track systems 2, 3 are operatively connected to the powertrain 7. In some instances, the front left and right track systems 2, 3 could be configured to replace front left and right wheels of the vehicle 1. Since the front track systems 2, 3 are similar (i.e., generally symmetrical about a longitudinal center plane of the vehicle 1), only the front track system 2 will be described herewith.

The track system 2, which has a front longitudinal end and a rear longitudinal end, includes a track-engaging assembly and an endless track 15 that is disposed around the track-engaging assembly. The track-engaging assembly includes a frame 16, which may sometimes be referred to as an undercarriage, and a plurality of wheel assemblies including a drive wheel assembly 14, support wheel assemblies 19 and idler wheel assemblies 17, 18. In the present embodiment, there are three support wheel assemblies 19 and two idler wheel assemblies 17, 18, but it is contemplated that the number of support and idler wheel assemblies may vary.

### Rear Track System

With continued reference to FIG. 1, the track system 4 is a rear left track system 4 and the track system 5 is a rear right track system 5. The track systems 4, 5 are operatively connected to the powertrain 7. In some instances, the rear left and right track systems 4, 5 could be configured to replace rear left and right wheels of the vehicle 1. Since the rear track systems 4, 5 are similar (i.e., generally symmetrical about a longitudinal center plane of the vehicle 1), only the rear track system 4, will be described herewith.

The track system 4, which has a front longitudinal end and a rear longitudinal end, includes a track-engaging assembly and an endless track 23 that is disposed around the track-engaging assembly. The track-engaging assembly includes a frame 24 and a plurality of wheels including a drive wheel assembly 22, support wheel assemblies 27 and idler wheel assemblies 25, 26. In the present embodiment, there are three support wheel assemblies 27 and two idler wheel assemblies 25, 26, but it is contemplated that the number of support and idler wheel assemblies may vary.

It should be noted that track systems with a variety of configurations and layouts are contemplated in the context of the present technology and, in particular, in the arrangements of the track systems. For instance, in some instances, the track systems could include tensioners to maintain tension in their endless tracks.

### Axle and Track System Assembly—Angular Limiting System

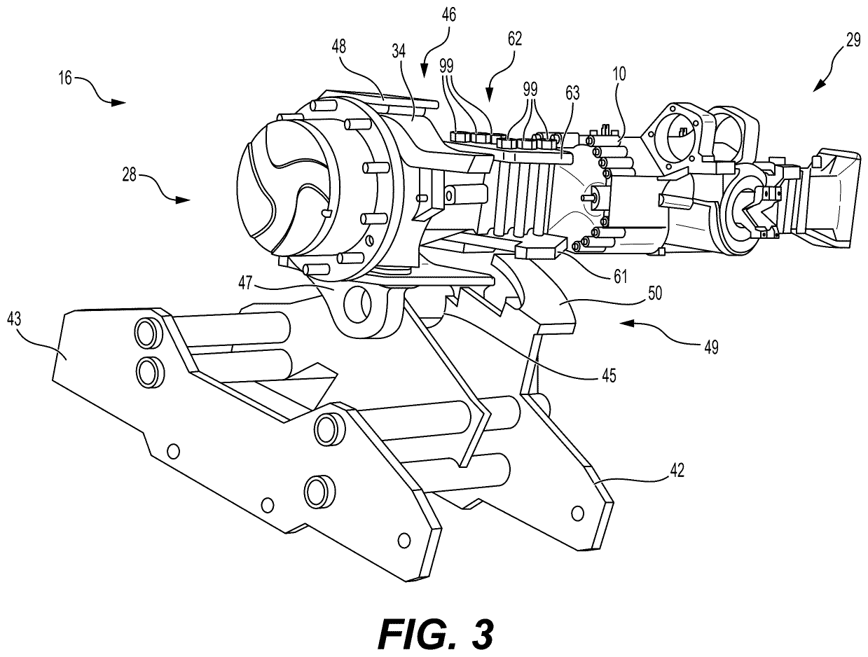

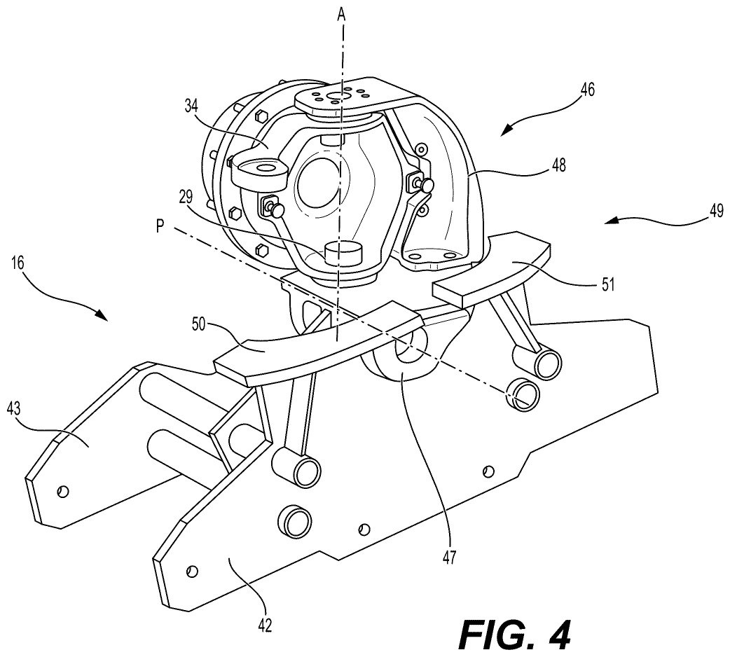

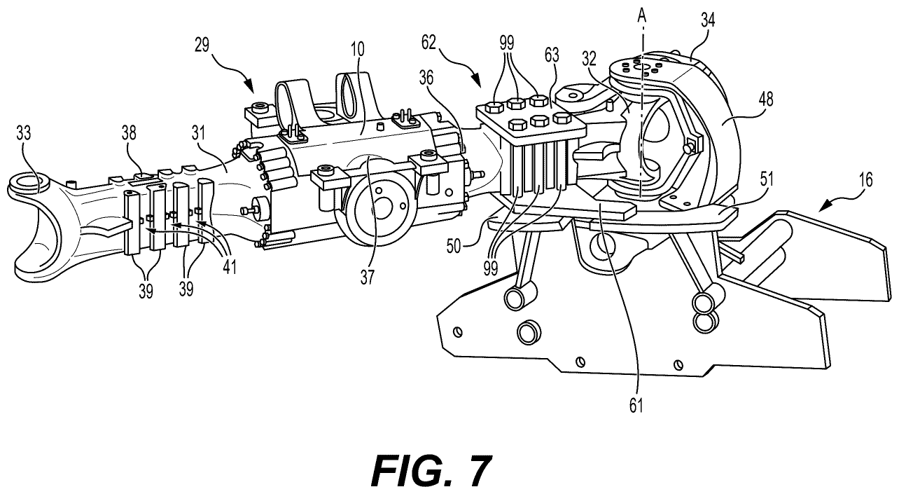

Referring to FIGS. 2 to 8, an angular limiting system 28, and an “axle-track system” assembly 29, which includes the angular limiting system 28, will now described.

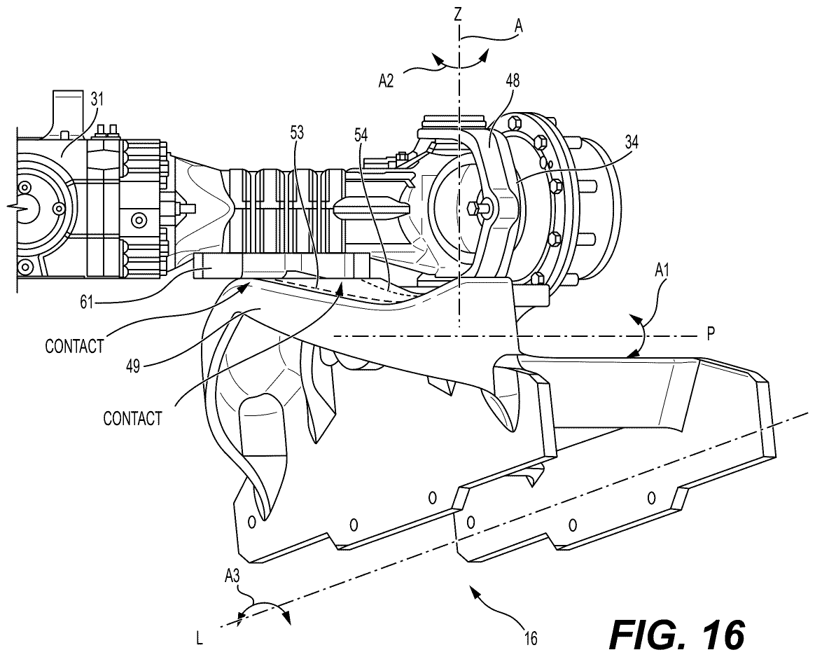

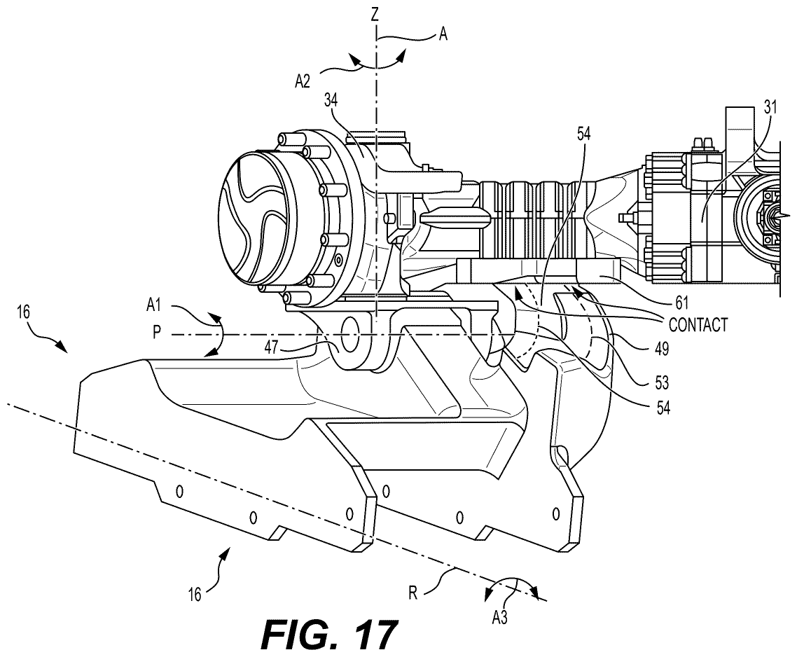

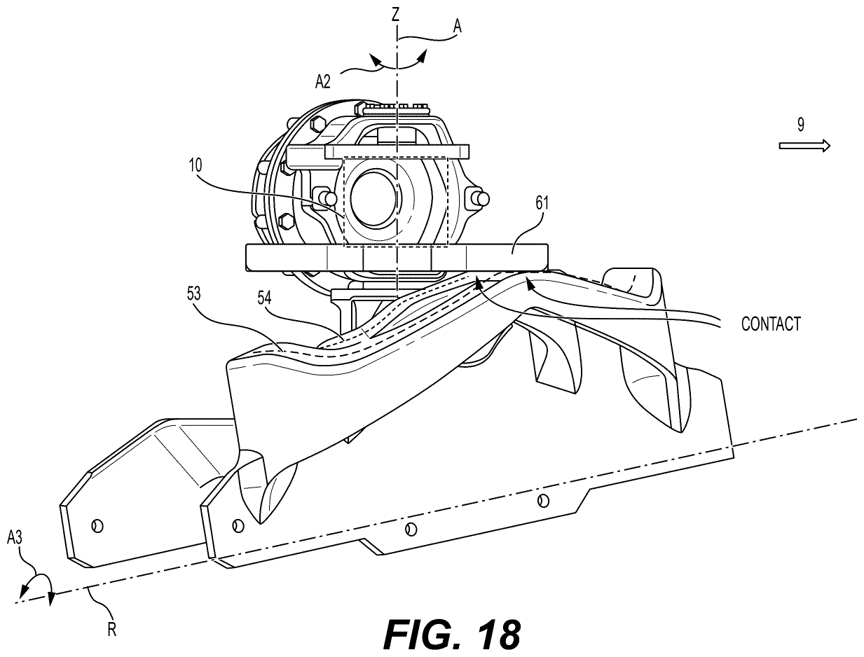

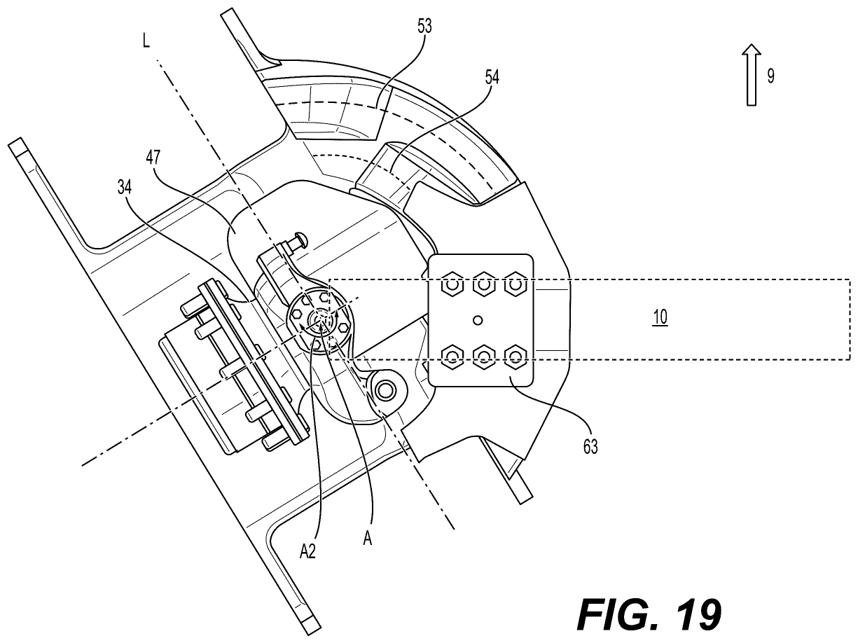

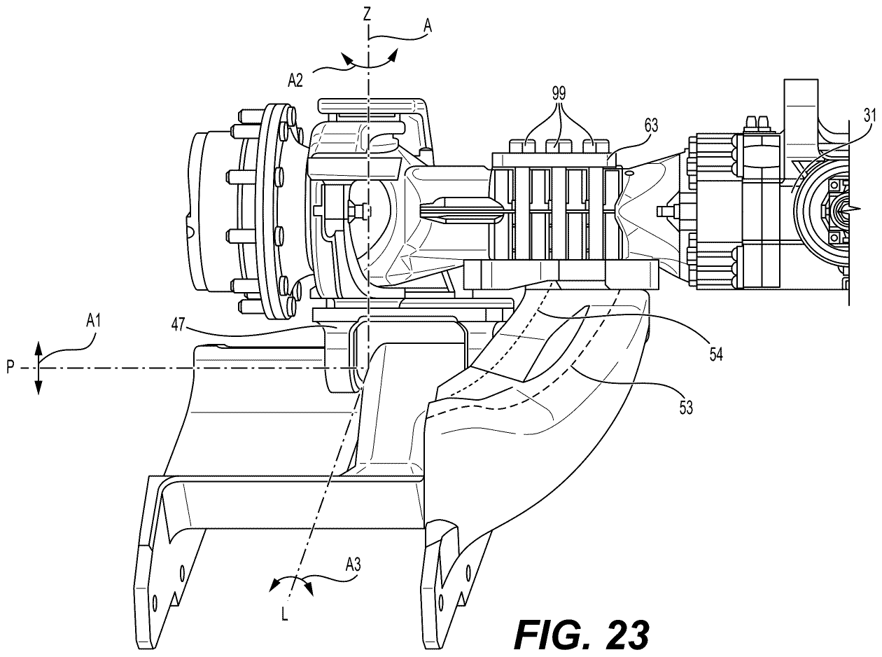

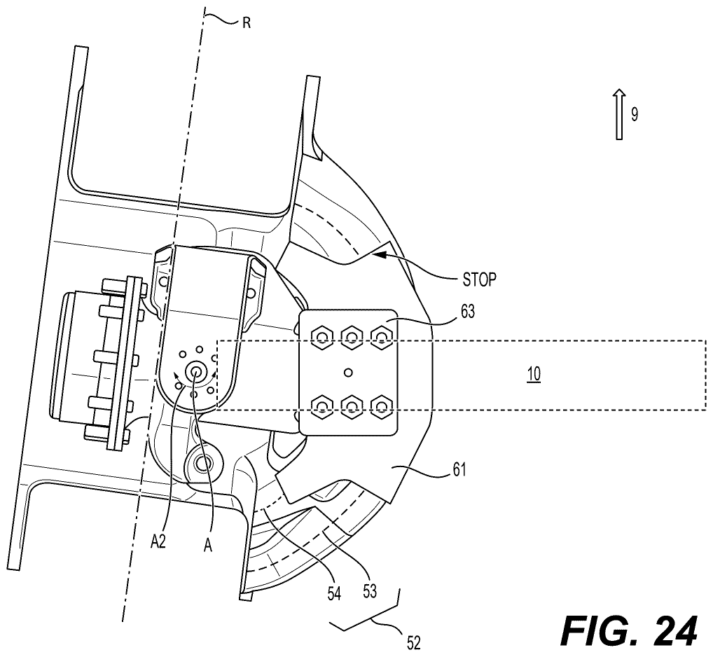

For the sake of brevity, the present description focuses on the track system 2 and the front axle 10, but it is understood that the present technology is applicable to the other track systems. In FIGS. 2 to 24, some components of the track system 2 (e.g. wheel assemblies, endless track 15, etc.) are omitted for sake of simplicity only.

As can be particularly seen from FIGS. 2, 13, and 15 to 17, the axle 10 has a body 31. The body 31 has an elongated shape with a left end 32 configured to operatively connect to the left track system 2 and a right end 33 configured to operatively connect to the right track system 3. When the vehicle 1 is moving in the forward direction, the body 31 extends generally laterally (i.e., along the Y-axis). The vehicle 1 has a steering knuckle 34 arranged to cooperate with the left end 32 of the body 31, and a steering knuckle (not shown) arranged to cooperate with the right end 33 of the body 31.

Focusing on the left end 32, the steering knuckle 34 is pivotable relative to the left end 32 about an axis A. The axis A may be referred to as a steering axis or as a yaw axis of the track system 2. With the vehicle 1 at rest on a flat, level ground surface and the track system 2 oriented in the forward direction, the axis A is oriented to extend generally vertically, but may be angled relative to at least one or the X-axis and Z-axis in some embodiments.

In some embodiments, it can be said that an axle assembly of the vehicle 1 includes the axle 10 and the steering knuckle 34 and is configured to (i) drive the drive wheel assembly 14 of the track system 2 and/or (ii) steer the frame 16 of the track system 2.

Also, the body 31 presents a left portion 36 between the left end 32 and a middle 37 of the body 31, as well as a right portion 38 between the middle 37 of the body 31 and the right end 33. Each of the left portion 36 and the right portion 38 includes ribs 39 (two ranges of four ribs as best seen in FIGS. 2, 7 and 8). The ribs 39 protrude from an external surface of the body 31, and are generally parallel to the steering axis A. Spaces 41 are defined between two consecutive ribs 39. As will be described below, the ribs 39 and the spaces 41 are configured to receive fasteners. Other configurations are contemplated as well.

Referring to FIGS. 2 to 4, the vehicle 1 is provided with an articulation assembly 46 that enables engagement between the track system 2 and the axle 10. The articulation assembly 46 includes a first element 47 coupled to a hub 45 of the frame 16 and a second element 48 (in a form of a C-bracket) that is coupled to the first element 47 and to the steering knuckle 34.

The frame 16 can vary in shape and size. According to a non-limiting embodiment, and referring to FIGS. 2 to 7, the undercarriage includes an internal portion 42 and an external portion 43. The internal and external portions 42, 43 are joined by four spacers 44. It is contemplated that the number of spacers 44 could vary from one embodiment to another.

The frame 16 has the hub 45. The hub 45 extends laterally outwardly, and defines a pivot axis P of the track system 2. The pivot axis P corresponds to the pitch axis of the track system 2.

The frame 16 also has an extension 49, which can be said to be part of the angular limiting system 28, as will be described later. A top surface of the extension 49 defines a first contact surface of the angular limiting system 28. As will be described below, the top surface of the extension 49 has a typology to limit movement of an axle member.

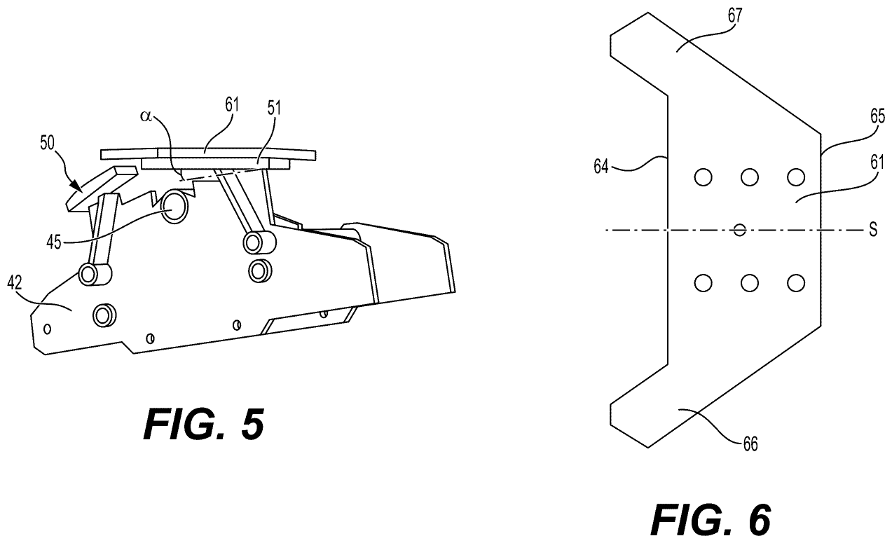

According to the embodiment illustrated in FIGS. 2 to 7, the extension 49 includes two arms 50, 51, which can be referred to as two members 50, 51. The two arms 50, 51 are disposed at the top of the internal portion 42, one on either longitudinal side of the hub 45, and therefore of the pitch axis P. Each one of the two arms 50, 51 defines an arcuate shape, and extend towards one another so as to generally form a C-letter. The arms 50, 51 are therefore curved arms. In the present embodiment, a space is defined between the two arms 50, 51. In some embodiments, this space may be omitted. As shown in FIG. 5, each arm 50, 51 defines an angle α with respect to a generally horizontal plane. The angle α is an acute angle. More specifically, the angle α is between about 2 degrees and about 85 degrees, advantageously between about 5 degrees and about 70 degrees, between about 8 degrees and about 45 degrees, or between about 8 degrees and about 30 degrees. In one embodiment, the angle is about 10 degrees. The top surfaces of the arms 50, 51 are generally flat. As will be explained later, the top surfaces of the arms 50, 51 are configured to cooperate with a bottom plate 61 of the axle 10 for limiting angular movement.

The vehicle 1 also includes the bottom plate 61. The bottom plate 61 may be referred to as a first plate or an “axle member” of the angular limiting system 28. Thus, in some embodiments, the bottom plate 61 may be considered as being part of the angular limiting system 28. A bottom surface of the bottom plate 61 defines a second contact surface of the angular limiting system 28. The bottom plate 61 is fastened to the axle 10 by a fastening device 62.

The fastening device 62 includes a top plate 63, sometimes referred to as a second plate and a plurality of bolts 99. The top plate 63 is connected to the bottom plate 61 by the plurality of bolts 99. Each bolt 99 is received in a respective space 41 of the axle 10. The bottom plate 61 and the top plate 63 face each other on both sides of the axle 10 and generally clamp the axle 10. In some embodiments, the axle 10 is configured to provide the bottom plate with the bottom surface.

The bottom plate 61 being fixed to the axle 10 (and not to the steering knuckle 34) assists in distributing loads and shocks to the axle 10 which is structurally more rigid and more resistant than the steering knuckle 34. In some cases, the track systems may be replacement for wheels. In such cases, the steering knuckles may be designed for connection to wheels, and would therefore be designed to sustain associated loads. Thus, bypassing the steering knuckles and distributing loads and shocks from the track systems to their respective axle can be beneficial for, notably, preventing damage to the steering knuckles.

Referring to FIG. 6, according to the present embodiment, the bottom plate 61 has a trapezoidal shape, with two parallel bases 64, 65 connected one to another by two legs 66, 67 that are angled relative to the parallel bases 64, 65. As will be described below, bottom surfaces of the legs 66, 67 are configured to cooperate with top surfaces of the arms 50, 51. The bottom plate 61 has a symmetrical plane S passing through midpoints of the bases 64, 65. It is contemplated that in other embodiments, the bottom plate 61 may be asymmetrical. The bottom plate 61 can be made of steel, or another material. As will be described in greater detail below, the bottom plate 61 forms a stopper of the track system when in contact with the extension 49.

### In Operation

The axle-track system assembly 29 is configured such that, the bottom plate 61 rests against the extension 49. In other words, the bottom surface of the bottom plate 61 (i.e., the second contact surface) is in contact with part of the top surface of the extension 49 (i.e., the first contact surface). Broadly, in response to the pitch angle of the track system 2 relative to the frame 6 of the vehicle 1 reaching a predetermined maximal value (i.e., the pitch angle reaching a limiting angle), the engagement between the bottom plate 61 and the extension 49 is such that movement of the track system 2 relative to the frame 6 about the pitch axis P is stopped. Angular movement of the track system 2 relative to the vehicle 1 about an axis (e.g. pitch axis and/or roll axis) is limited to a safe range of motion, such that the present technology can prevent potential unwanted contact between the track system 2 and the frame 6 of the vehicle 1. In some embodiments, the axle-track system assembly 29 could be configured to limit angular movement of the track system 2 relative to the vehicle 1 about a yaw axis. Hence, the angular limiting system 28 can optimize driving performance of the vehicle 1 on uneven surfaces.

### Alternative Embodiment

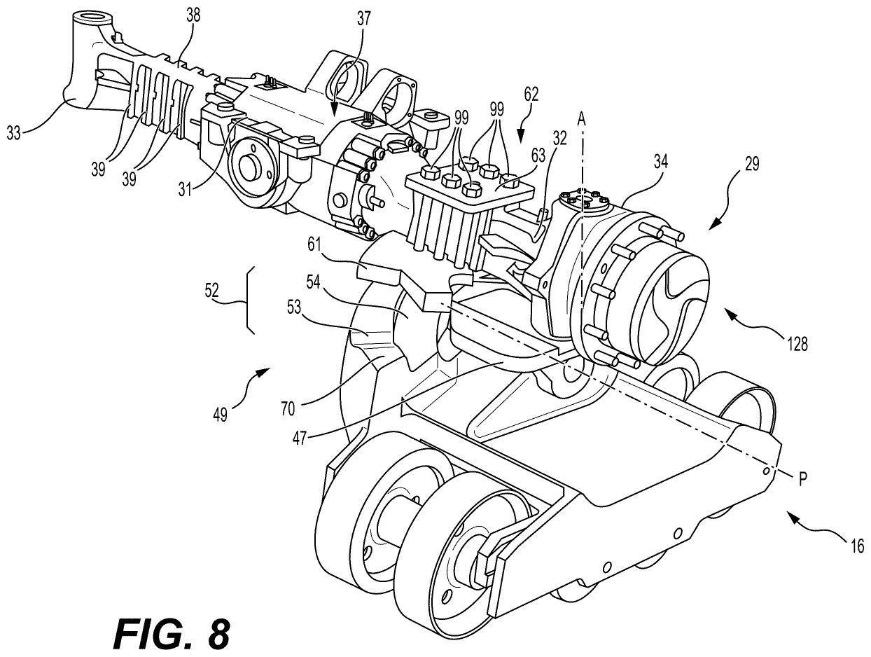

Referring to FIGS. 8 to 24, an alternative embodiment of the present technology, namely angular limiting system 128, will now be described. Features of the angular limiting system 128 similar to those of the angular limiting system 28 have been labeled with the same reference numerals, and will not be described in detail herewith.

Referring to FIGS. 8 to 10, the angular limiting system 128 notably differs from the angular limiting system 28 in that the extension 49 includes a path 52 with two generally parallel races: an external race 53, and an internal race 54. A race can be described as a track or channel in which something rolls or slides. The internal race 54 is disposed between the external race 53 and the hub 45. The race 53 defines a topography of the contact surface of the extension 49 from a first end 55 to a second end 57 through a middle 59, and the race 54 defines a topography of the contact surface of the extension 49 from a first end 56 to a second end 58 through a middle 60.

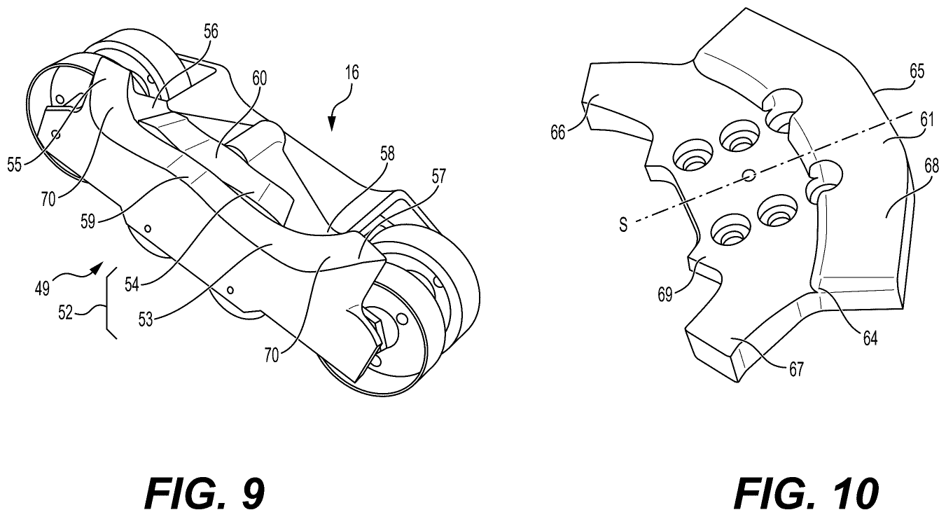

As shown for instance in FIG. 9, the external race 53 (relative to the frame 16) has a generally inversed V shape with the middle 59 defining the peak of the V-shape, and the ends 55, 56 extending upwardly from the middle 59 and corresponding to branches of the V-shape. The internal race 54 has a generally flat portion at the middle 60, and defines a V-shaped inclined portion, with the ends 57, 58 being generally flat after the V-shaped portion. As will be described later, the path 52 is arranged to cooperate with the bottom plate 61.

Referring to FIG. 10, in this embodiment, the bottom plate 61 includes a main body. The main body has a first portion 68, and a second portion 69. A thickness of the first portion 68 is greater than a thickness of the second portion 69. The bottom plate 61 has a shoulder defining a base 64 between the first and second portions 68, 69. The second portion 69 has two legs 66, 67. The first portion 68 has an external curved edge of the same shape as that of a perimeter of an external edge of the external race 53. The bottom plate 61 has a symmetry plane S passing through the midpoints of the bases 64, 65. In some embodiments, the bottom plate 61 may be asymmetrical.

The angular limiting system 128 is configured to limit the pivotal movement of the track system 2 relative to the frame 6 of the vehicle 1 about the pitch axis P to a predetermined limiting angle by engagement of the first and second contact surfaces. In some embodiments, the predetermined limiting angle is configured to allow a range of motion about the pitch axis P of about 80 degrees, about 60 degrees, about 45 degrees, about 30 degrees, about 20 degrees, about 10 degrees, or about 5 degrees.

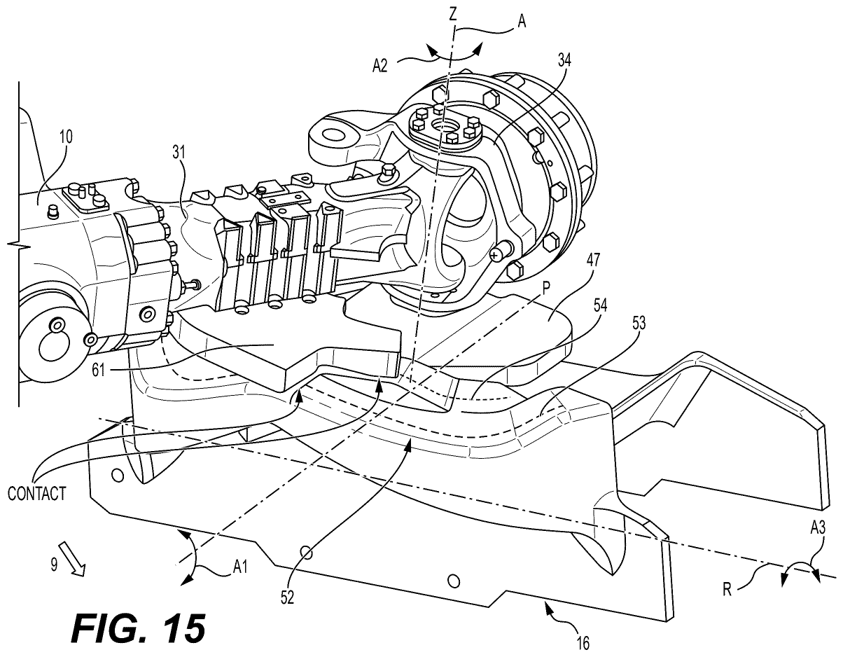

Additionally, when the track system 2 is steered due to a pivotal movement A2 (FIG. 15) about the yaw axis (or steering axis A), the angular limiting system 128 is configured to limit the pivotal movement A2 to a predetermined limiting angle via stoppers 70. In some embodiments, the predetermined limiting angle about the yaw axis is about 80 degrees, about 60 degrees, about 45 degrees, about 30 degrees, about 20 degrees, about 10 degrees, about 5 degrees.

Additionally, the track system 2 may also be tilted due to a pivotal movement A3 about the roll axis. The angular limiting system 128 is configured to limit the pivotal movement A3 to a predetermined limiting angle via stoppers 70. In some embodiments, the predetermined limiting angle about the roll axis is about 80 degrees, about 60 degrees, about 45 degrees, about 30 degrees, about 20 degrees, about 10 degrees, or about 5 degrees.

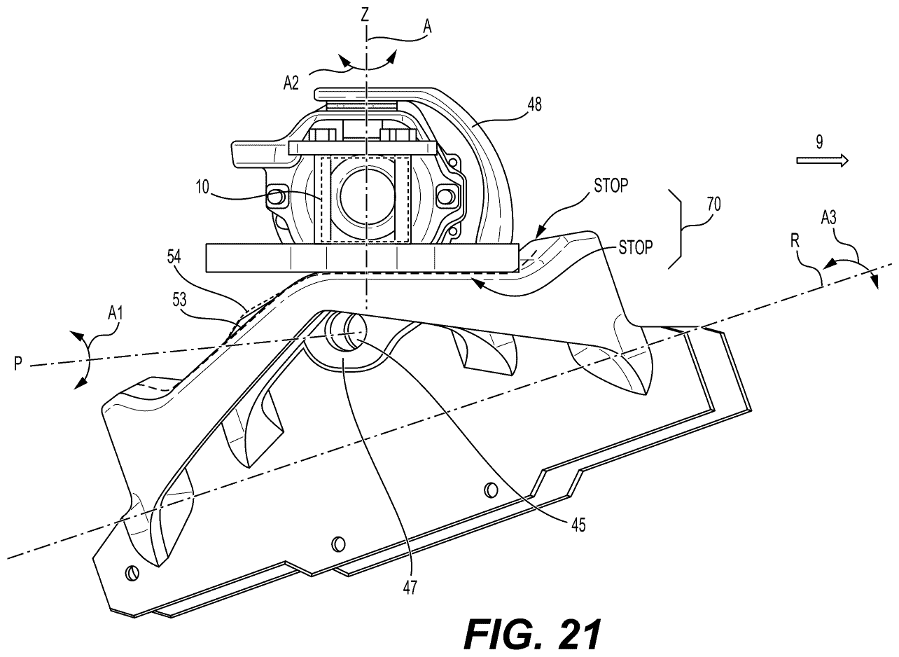

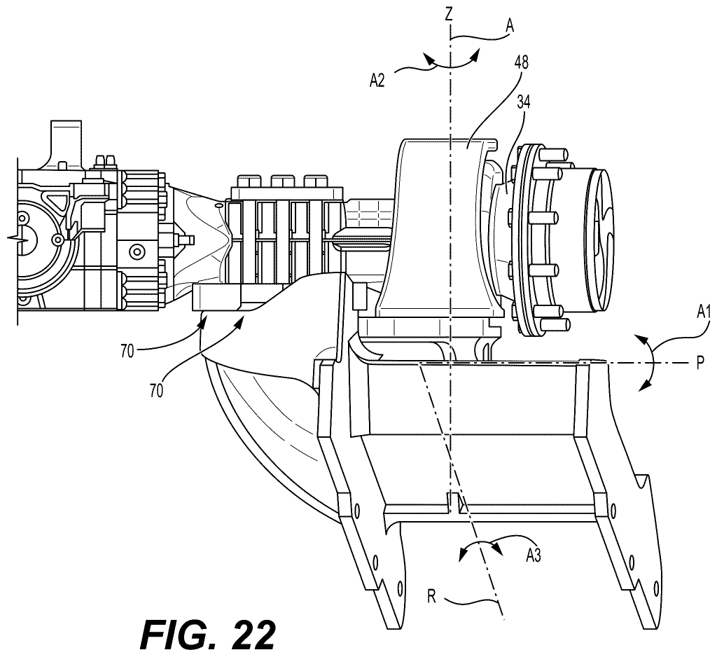

As will be described below, stoppers 70 are on given portions of the external race 53 and/or internal race 54 and can come in contact with the bottom surface of the bottom plate 61 for stopping relative movement between the bottom plate 61 and the frame 16, as illustrated for instance in FIGS. 21 and 22.

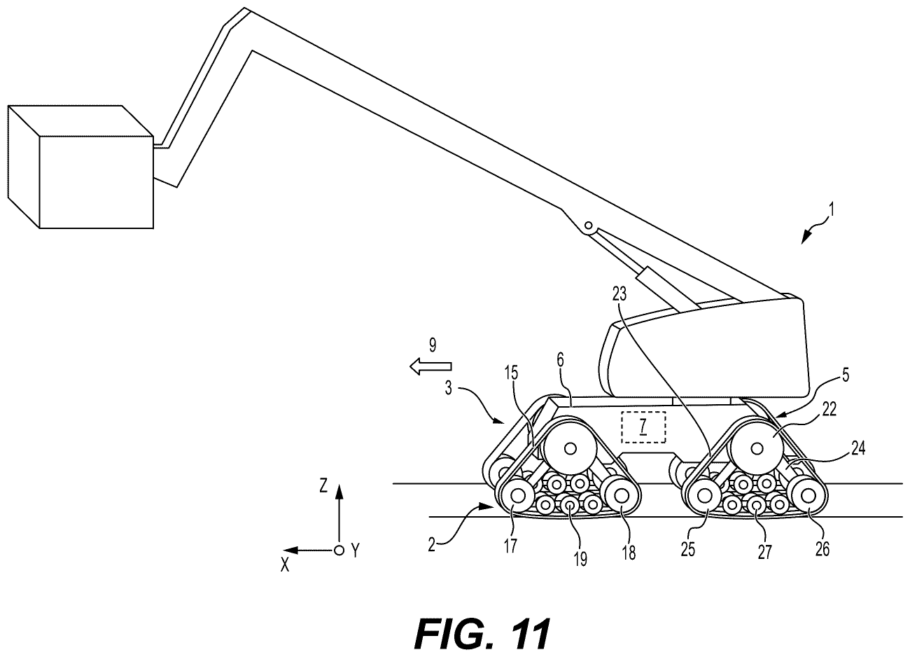

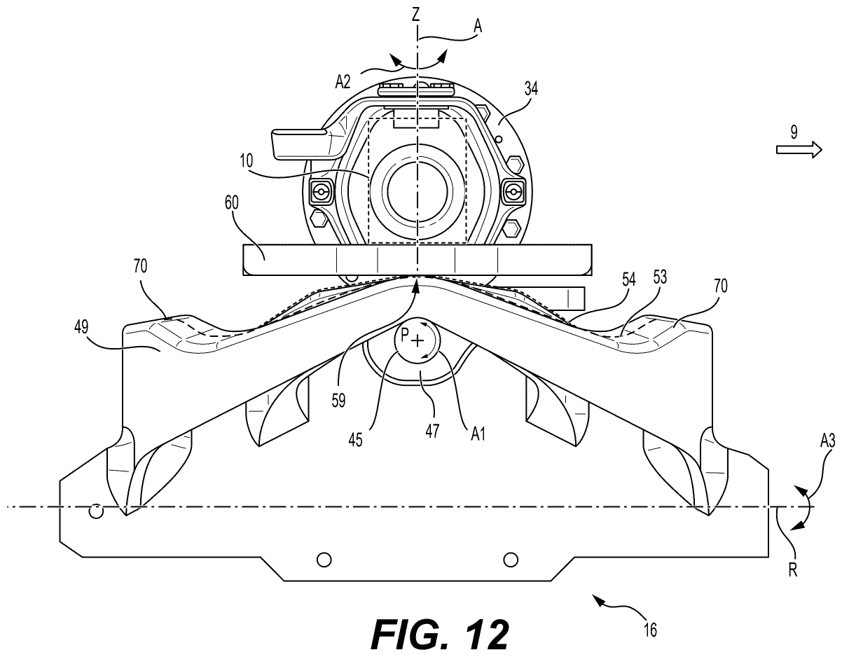

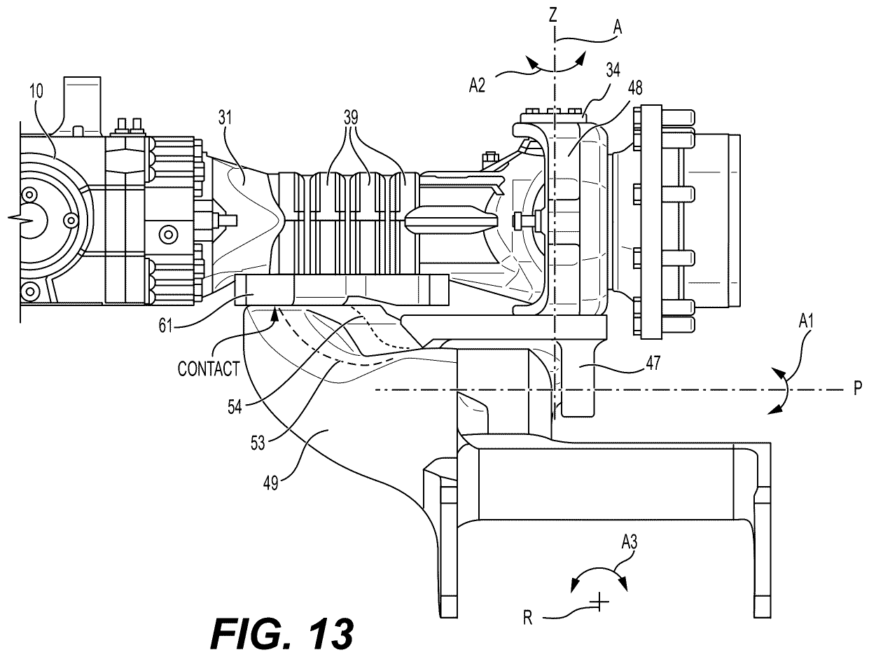

Referring to FIG. 11, the vehicle 1 is shown with the track systems being oriented in a forward direction, and resting on a flat level surface. FIGS. 12 and 13 depict the axle-track system assembly 29 when an angle about the pitch axis P is zero, and when an angle about the yaw axis A is zero.

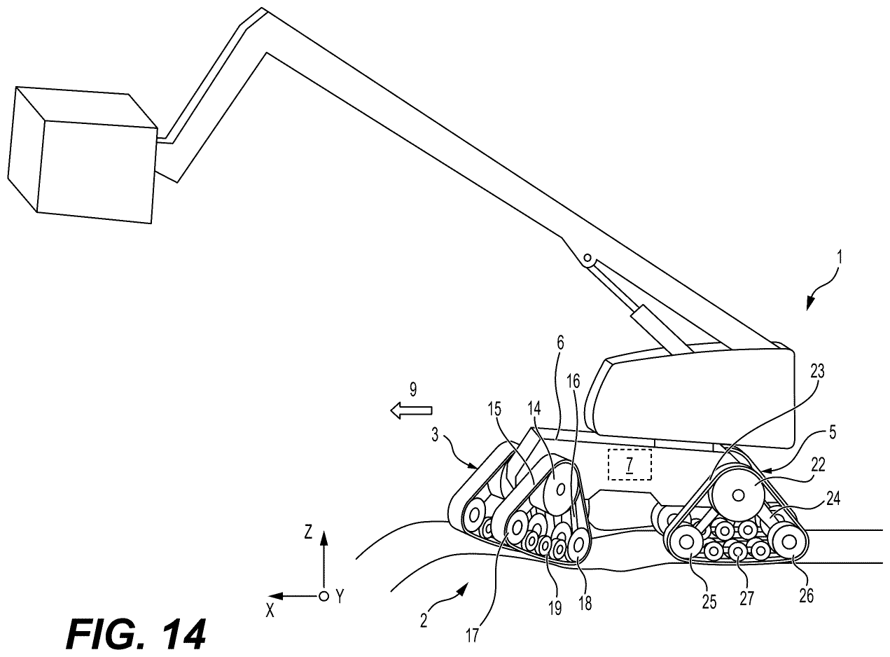

Referring to FIG. 14, the vehicle 1 is shown with the track systems 2, 3, (each of which is equipped with the angular limiting systems 128) steered in the left direction and climbing a sloped terrain. The track systems 2, 3 are therefore angled about the pitch axis P and angled about the steering axis A. In this instance, the angle of the track systems 2, 3 about the pitch axis P is less than the predetermined limiting angle, and the angle of the track systems 2, 3 about the steering axis A less than a corresponding predetermined limiting angle. Thus, being that the pitch and yaw angles are less than the predetermined limiting angles, movement of the track system 2 is not stopped by the stoppers 70. In FIGS. 14 to 19, the axle-track system assembly 29 is depicted with an angle about the pitch axis P being greater than zero but less than the predetermined maximum angle in pitch, and with an angle about the yaw axis being greater than zero but less than the predetermined maximum angle in yaw.

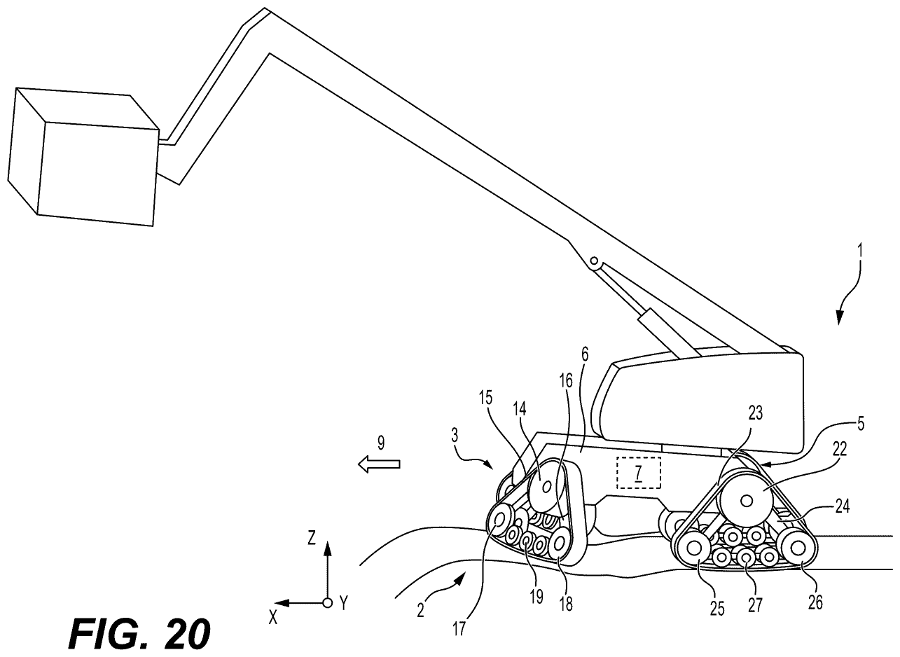

Referring to FIG. 20, the vehicle 1 is shown with the track systems 2, 3 (each of which is equipped with the angular limiting systems 128) steered in the right direction and climbing a sloped terrain. The track systems 2, 3 are therefore angled about the pitch axis P and angled about the steering axis A. In this instance, the angle of the track systems 2, 3 about the pitch axis P is at the predetermined limiting angle, and the angle of the track systems 2, 3 about the steering axis A is also at the corresponding predetermined limiting angle. Thus, movement of the track system 2 relative to the frame 6 is stopped by the stoppers 70. Therefore, FIGS. 21 to 24 depict the axle-track system assembly 29 when an angle about the pitch axis P is at the predetermined maximum angle in pitch, and when an angle about the yaw axis is at the predetermined maximum angle in yaw.

When the track system is angled due to a pivotal movement A1 about the pitch axis P, and steered due to a pivotal movement A2 about the yaw axis (or steering axis A), (i.e., the track system is pivoted about a composite angle relative to the vehicle), the angular limiting system 128 is configured to limit the pivotal movement A1 to a predetermined limiting angle via stoppers 70 while also being configured to limit the pivotal movement A2 to a predetermined limiting angle via stoppers 70. In some embodiments, the angular limiting system 128 is configured to allow a composite range of motion of about 80 degrees about the yaw axis (or steering axis A), about 60 degrees about the yaw axis (or steering axis A), about 45 degrees about the yaw axis (or steering axis A), about 30 degrees about the yaw axis (or steering axis A), about 20 degrees about the yaw axis (or steering axis A), about 10 degrees about the yaw axis (or steering axis A), about 5 degrees about the yaw axis (or steering axis A).

In some cases, the pivotal movement A3 about the roll axis may be provided by the connection between the support wheel assemblies 19 and the frame 16 such that the pivotal movement A3 would being independent from the angular limiting system 128, but complementary thereto. It will be appreciated that support wheel assemblies 19 pivoting relative to the frame 16 would typically not affect risk of contact between the track system and the frame of the vehicle. In some other cases, the configuration, shape and/or design of the angular limiting system 128, such as contact surfaces, stoppers, races, or pivots, may be adapted to allow an optimized range of motion about any single pivotal movement (e.g. A1, A2, and/or A3) and/or about a composite range of motion including any combination of components about pivotal movements A1, A2, and/or A3.

When the pivotal motions A1, A2, and/or A3 are within the range of motion defined by the corresponding limiting angles, the first contact surface and the second contact surface are in contact via the first and second races. More specifically, the external and internal races 53, 54 act like cam surfaces onto which the bottom plate 61 slide, changing a distance between the first contact surface and the second contact surface.

As already mentioned, stoppers 70 are disposed on a given portion of the external race 53 and/or internal race 54, and are configured to come in contact with the bottom surface of the bottom plate 61. The position of the stoppers 70 on the external and internal races 53, 54 depends on the pivotal movement of the track system around respective axes.

It will be appreciated that according to the present technology, the composite range of motion of the track systems is optimized to any composite axis having any combination of components on pitch axis, yaw axis (or steering axis) and/or roll axis, compared to conventional track systems which may only limit angle the pitch axis or the yaw axis.

In other words, for a given first pivotal movement about a first axis, a given one of the first and second races is shaped and configured to guide the motion of the track system relative to the frame of the vehicle about the first axis up to a first pre-determined limit, while an other one of the first and second races is shaped and configured to guide the motion of the track system relative to the vehicle about a second axis up to a second predetermined limit. The cooperative guidance provided by the first and second races to the bottom plate allows an optimized position and orientation of the track system relative to the vehicle for any given combination of the first pivotal movement and the second pivotal movement up to a third limit that resulting from said any given combination.

For example, but without being limited to, the track system may be moved according to a first pivotal movement (e.g., about the yaw axis or a steering axis) by a first angle where the first race guides said first pivotal movement until a predetermined limiting angle in a first orientation is reached, while the track system also being moved according to a second pivotal movement (e.g., about the pitch axis and/or roll axis) by a second angle where the second race guides said second pivotal movement up until a predetermined limiting angle in a second orientation is reached, where the limiting angle may be a combination of components about the first pivotal movement (e.g. yaw axis or steering axis) and the second pivotal movement (e.g., pitch axis and/or roll axis) corresponding to an angle optimized for the given position and orientation of the track system relative to the vehicle (i.e., first and second angles). This optimized angle therefore allows an optimized range of motion of the track system relative to the vehicle. Thus, the angular limiting system 128 broadly allows the track system to move farther (i.e., closer to the vehicle without risking contacting it) in a composite motion, therefore enabling an improved performance to accommodate to uneven terrain, for instance, compared to conventional devices limiting a track system in a single given pivotal movement at the time and being then set to provide a conversative limit based on a worst-case scenario (e.g., maximal steering and maximal pitch) applied to any other pivotal movement—even if said limit could have been farther actually in some cases (e.g., composite motion).

When the limiting angle is reached, stresses are distributed to the bottom plate 61 and to the top plate 63 via the stoppers 70, and then to the axle 10. Hence, the repartition of the stresses can decrease likelihood of the steering knuckle 34 of breaking. It can therefore be said that the angular limiting system 128 generally can decrease likelihood of the vehicle of being damaged.

Furthermore, according to the second illustrated embodiment, the topography of the contact surface of the extension 49 is configured such that the limiting angle is determined for each steering angle. In other words, the angular limiting system 128 ensures the optimization of the limiting angle as a function of the steering angle. This results in the optimization of the position and orientation of the track system relative to the frame of the vehicle as function of the steering angle. Thus, when the vehicle is not used in the worst-case conditions (fully steered, tilted), the limiting angle is not constrained by the worst-case conditions, which can greatly improve the performance of the track system and thus use of the vehicle.

### Other Embodiments

The present technology is not limited to the illustrated embodiments. For instance, it is contemplated that the contact surface of the bottom plate can have flat, convex and/or concave portions. Also, the contact surface of the bottom plate 61 can have a coating or a surface cover made of a material providing a low friction coefficient (Ultra-High Molecular Weight, for example) or can include a roller to reduce the friction with the arms 50, 51. Furthermore, a lubricant (like grease) may be added between the bottom surface of the bottom plate and the top surface of the arms 50, 51.

Moreover, the complex geometry of the contact surface of the extension and the simple geometry of the contact surface of the bottom plate could be exchanged, if the extension needs to be simplified, for instance. In some cases, both contact surfaces of the top and bottom plates may have a complex geometry so that the cooperation thereof may allow motions optimized for a given steering angle of the track system relative to the vehicle.

In some instances, the extension 49 may be integral to the frame 16, or may be an independent extension that is selectively connected to the frame 16 of a track system when needed (i.e., retrofit). The bottom plate could also be integral to the axle, rather than be connected thereto.

1. An angular limiting system for a track system configured to be drivingly connected to an axle of a vehicle, and to be pivotally connected to the axle about an axis, the angular limiting system comprising:
an axle member configured to be connected to the axle of a vehicle; and
a frame member configured to be connected to a frame of the track system, and configured to cooperate with the axle member for limiting movement of the track system in response to an angle between part of the track system and the axle about the axis reaching a predetermined angular limit.

2. The angular limiting system of claim 1, wherein:
the axis is a pitch axis and the angle is a pitch angle of the track system;
the axis is a roll axis and the angle is a roll angle of the track system; or
the axis is a yaw axis and the angle is a yaw angle of the track system.

3. The angular limiting system of claim 1, wherein:
the angular limiting system further comprises a plate configured to connect to the axle;
the frame member comprises an extension comprising an external surface; and
the plate and the external surface are positioned to be in contact for limiting relative movement about the axis.

4. The angular limiting system of claim 1, wherein:
the axis is a first axis;
the angle is a first angle;
the predetermined angular limit is a first predetermined angular limit; and
the track system is further configured to pivot relative to the axle about a second axis, and the frame member is configured to cooperate with the axle member for limiting movement of the track system in response to a second angle between part of the track system and the axle about the second axis reaching a second predetermined angular limit.

5. The angular limiting system of claim 4, wherein:
the first axis is one of:
a pitch axis, and the first angle is a pitch angle of the track system;
a roll axis, and the first angle is a roll angle of the track system; or
a yaw axis, and the first angle is a yaw angle of the track system,
the second axis is an other one of:
the pitch axis, and the second angle is a pitch angle of the track system;
the roll axis, and the second angle is a roll angle of the track system; or
the yaw axis, and the second angle is a yaw angle of the track system.

6. The angular limiting system of claim 4, wherein:
the angular limiting system further comprises a plate configured to be connected to the axle;
the frame member comprises an extension comprising an external surface; and
the plate and the external surface are positioned to be in contact so as to limit relative movement about the first axis and the second axis.

7. The angular limiting system of claim 6, wherein the extension comprises at least two races forming cam surfaces configured to engage the plate.

8. The angular limiting system of claim 7, wherein the plate is configured to slide on the at least two races.

9. The angular limiting system of claim 8, wherein the races are shaped to provide a composite range of motion of about 80 degrees about the first axis and the second axis.

10. The angular limiting system of claim 9, wherein the races are shaped to allow a composite range of motion of about 60 degrees about the first axis and the second axis.

11. The angular limiting system of claim 9, wherein the races are shaped to allow a composite range of motion of about 5 degrees about the first axis and the second axis.

12. The angular limiting system of claim 1, wherein:
the axle member is configured to be selectively connected to the axle; or
the axle member is configured to be integral with the axle.

13. The angular limiting system of claim 1, wherein:
the frame member is configured to be selectively connected to the frame; or
the frame member is configured to be integral with the frame.

14. The angular limiting system of claim 1, wherein the frame member has a frame plate defining an angle with a horizontal plane.

15. The angular limiting system of claim 14, wherein the angle is between about 5° and about 45°.

16. The angular limiting system of claim 1, wherein:
the frame member is a first frame member; and
the angular limiting system further comprises a second frame member configured to be connected to the frame, and configured to cooperate with the axle member for limiting movement in response to angle between part of the track system and the axle about the axis reaching a second limiting angular value.

17. The angular limiting system of claim 1, wherein the frame member comprises at least one surface with a typology arranged such that:
with a yaw angle of the track system being a first yaw angular value, the limiting angular value is a first limiting angular value;
with the yaw angle of the track system being a second yaw angular value, the limiting angular value is a second limiting angular value; and
the first limiting angular value is different from the second limiting angular value.

18. The angular limiting system of claim 1, wherein the frame member has stoppers.

19. A track system comprising:
a frame configured to connect to an axle of a vehicle, the frame being pivotable relative to the frame about an axis;
a plurality of wheel assemblies rotationally connected to the frame, the plurality of wheel assemblies including a drive wheel assembly configured to be drivingly connected to the axle of the vehicle;
an endless track surrounding the plurality of wheel assemblies and drivingly engaged with the drive wheel assembly; and
the angular limiting system in accordance with claim 1.

20. A vehicle comprising:
a frame;
a motor supported by the frame;
an axle supported by the frame and operatively connected to the motor;
a track system drivingly and pivotably connected to the axle; and
the angular limiting system of claim 1.
